(19) United States
(12) Patent Application Publication
(10) Pub. No.: US 2017/0302321 A1
(43) Pub. Date: Oct. 19, 2017

(54) PORTABLE ELECTRONIC DEVICE HOLDER FOR USE IN A VEHICLE

(71) Applicant: Ford Global Technologies, LLC, Dearborn, MI (US)

(72) Inventors: Scott Clark, Ypsilanti, MI (US); Mark Wells, Dearborn, MI (US)

(73) Assignee: Ford Global Technologies, LLC

(21) Appl. No.: 15/097,701

(22) Filed: Apr. 13, 2016

(51) Int. Cl. H04B 1/3877; H04M 1/04; H04B 1/3822

(52) U.S. Cl. CPC H04B 1/3877; H04B 1/3822; H04M 1/04

(57) ABSTRACT

A portable electronic device holder of a vehicle is provided herein. A housing defines a space therein and has an open end. A first and second number of retention members are coupled to opposing side walls of the housing and are disposed to extend into the space. The first and second number of retention members cooperate to hold a portable electronic device inserted into the space through the open end.

### FIELD OF THE INVENTION

The present invention generally relates to portable electronic device holders, and more particularly, to portable electronic device holders for use in a vehicle.

### BACKGROUND OF THE INVENTION

The popularity of portable electronic devices is ever increasing. However, vehicle storage compartments are not typically designed to securely hold a portable electronic device therein. While aftermarket portable electronic device holders are available, they generally require user assembly and can be unappealing to the eye. Accordingly, there is a need for a portable electronic device holder that is already assembly to a vehicle and is capable of securely holding a portable electronic device in place during operation of the vehicle.

### SUMMARY OF THE INVENTION

According to one aspect of the present invention, a portable electronic device holder of a vehicle is provided. A housing defines a space therein and has an open end. A first and second number of retention members are coupled to opposing side walls of the housing and are disposed to extend into the space. The first and second number of retention members cooperate to hold a portable electronic device inserted into the space through the open end.

According to another aspect of the present invention, a portable electronic device holder of a vehicle is provided. A clamshell housing has a living hinge and defines a space therein and an open end. A first and second number of flexible retention members are integrated with opposing side walls of the housing and are disposed to extend into the space. The first and second number of flexible retention members cooperate to hold a portable electronic device inserted into the space through the open end.

According to yet another aspect of the present invention, a portable electronic device holder of a vehicle is provided. A housing defines a space therein and an open end. An odd and an even number of retention members are integrated with opposing side walls of the housing and are disposed to extend into the space. One of the odd and even number of retention members are located at a lower depth than a depth at which the other of the first and second number of retention members are located within the housing. The odd and even number of retention members cooperate to hold a portable electronic device inserted at an angle into the space through the open end. The odd and even number of retention members are flexible and include a tip portion that deforms against the portable electronic device to apply sufficient gripping force against the portable electronic device to prevent the electronic device from slipping out of position.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 shows an interior compartment of a vehicle having a number of portable electronic device holders configured as bins and each holding a portable electronic device in a secured position;

FIG. 2 is a rear perspective view of a portable electronic device holder according to one embodiment;

FIG. 3 is a top view of the portable electronic device holder of FIG. 2;

FIG. 4 is a side view of the portable electronic device holder of FIG. 2;

FIG. 5 is a front view of the portable electronic device holder of FIG. 2;

FIG. 6 is rear perspective view of the portable electronic device holder of FIG. 2 optionally showing a clamshell housing and a living hinge;

FIG. 7 is a rear perspective view of a portable electronic device holder according to another embodiment;

FIG. 8 is a top view of the portable electronic device holder of FIG. 7;

FIG. 9 is a side view of the portable electronic device holder of FIG. 7;

FIG. 10 is a front view of the portable electronic device holder of FIG. 7; and

FIG. 11 is rear perspective view of the portable electronic device holder of FIG. 7 optionally showing a clamshell housing and a living hinge.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

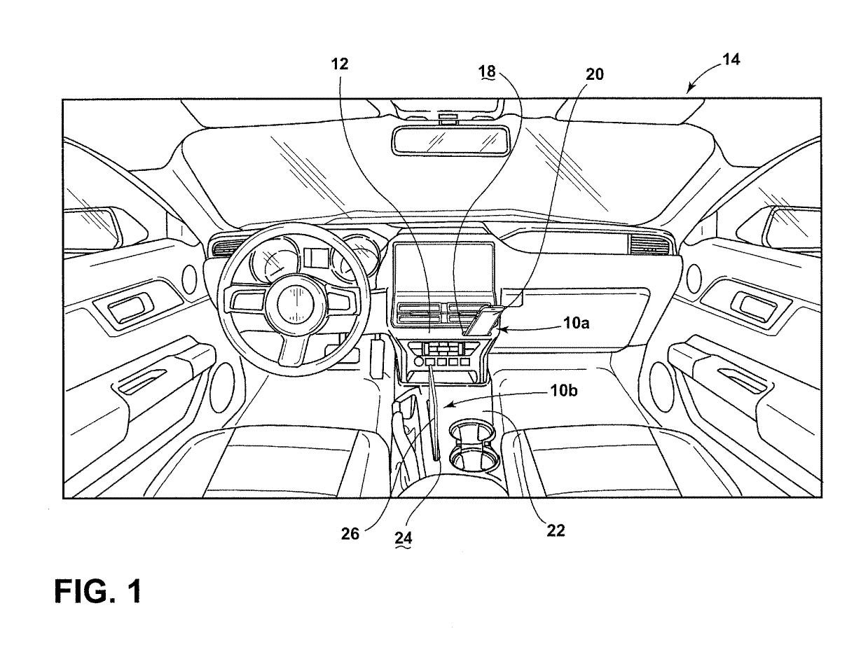

Referring to FIG. 1, a portable electronic device holder 10a, embodied as a portable electronic device holder, is assembled to a center stack 12 of a vehicle 14. The portable electronic device holder 10a is exemplarily provided below an instrument panel 16 and is generally accessible by an occupant in the front passenger compartment. As shown, the portable electronic device holder 10a includes an opening 18 through which a portable electronic device, exemplarily shown as smart phone 20, is received therethrough. In the illustrated embodiment, smart phone 20 is held in portable electronic device holder 10a at an upward angled position, but may alternatively be held in the portable electronic device holder 10a at a downward angled position or a flat position in other embodiments. As further illustrated in FIG. 1, another portable electronic device holder 10b, also embodied as a bin, is exemplarily shown assembled to a center console 22 and is also generally accessible by an occupant in the front passenger compartment. As shown, portable electronic device holder 10b includes an opening 24 that is larger in both length and width than that of portable electronic device holder 10a and through which a portable electronic device, exemplarily shown as tablet 26, is received therethrough and is held in portable electronic device holder 10b at an upright position. As described herein, portable electronic device holders 10a and 10b are each configured to tightly secure their respective portable electronic devices therein, thereby preventing the portable electronic devices from being bumped around and possibly damaged during operation of the vehicle 14. It is contemplated that additional portable electronic device holders may be similarly assembled to other interior structures of the vehicle 14 such as an overhead console or other control bearing surfaces located in the front passenger compartment or the rear passenger compartment.

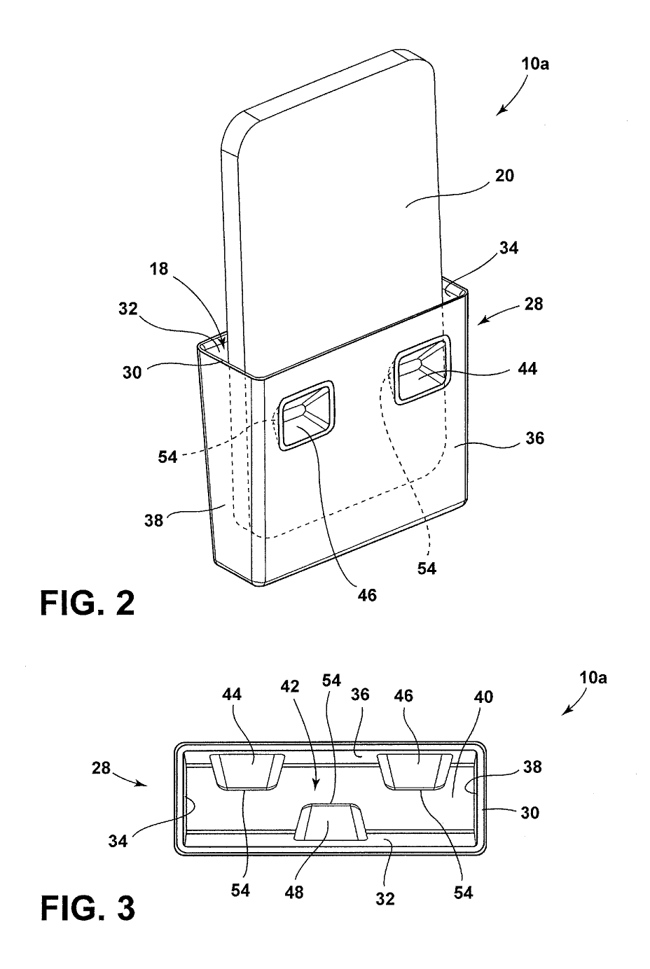

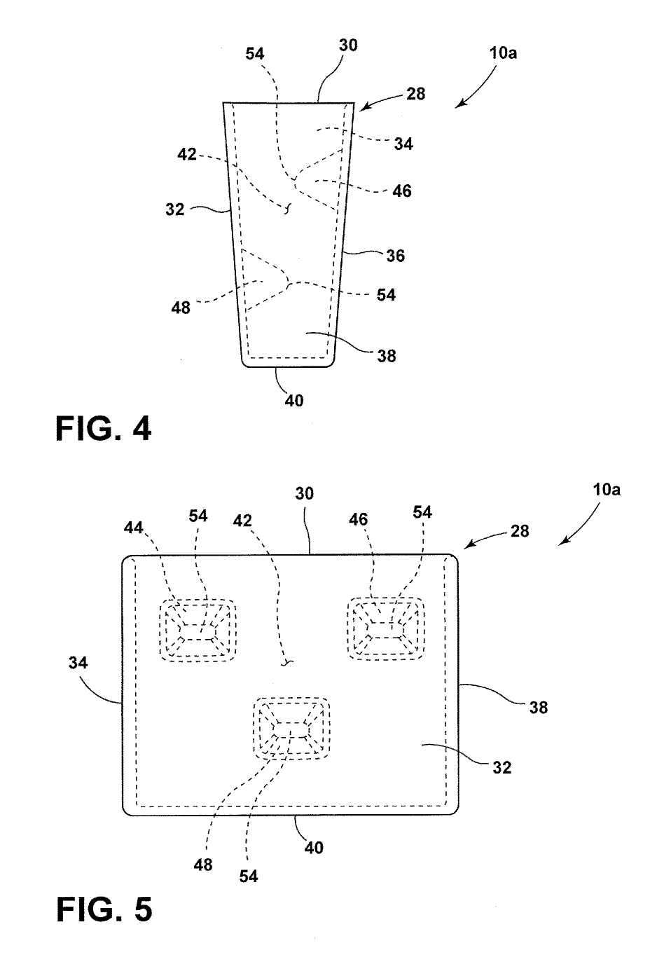

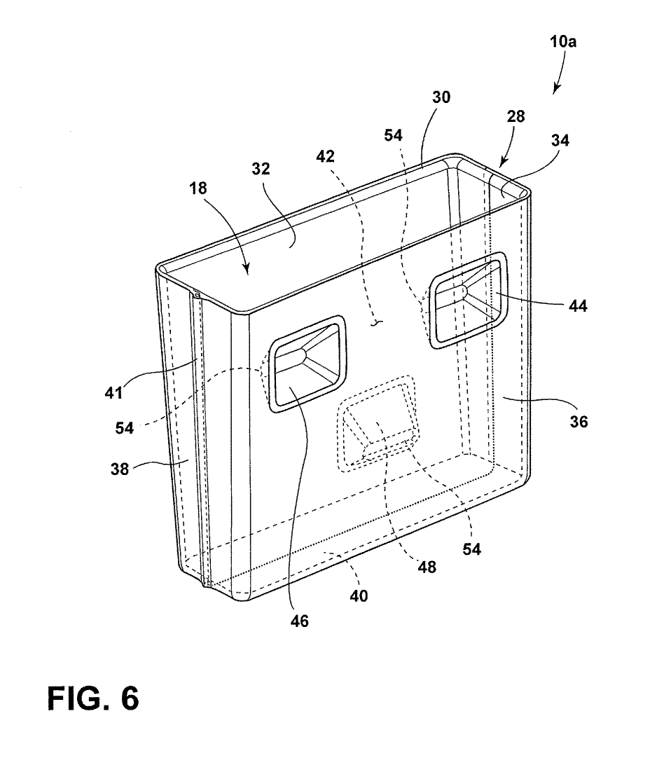

Referring now to FIGS. 2-6, portable electronic device holder 10a is shown according to one embodiment. As shown, portable electronic device holder 10a includes a housing 28 that may be molded from a thermoplastic polymer such as polypropylene or thermoplastic olefin (TPO). The housing 28 includes a top end 30 that defines the opening 18 shown in FIG. 1, side walls 32, 34, 36, and 38, and bottom end 40. In the present embodiment, side walls 34 and 38 are substantially perpendicular with respect to the top and bottom ends 30, 40 whereas side walls 32 and 36 taper toward the bottom end 40. Alternatively, side walls 32 and 36 may be substantially perpendicular with respect to the top and bottom ends 30, 40 of the housing 28. Optionally, the housing 28 may be configured as a clamshell and include a living hinge 41 extending longitudinally across one of the side walls such as side wall 38, as exemplarily shown in FIG. 6. The housing 28 defines a space 42 for accommodating the smart phone 20 when it's inserted into the housing 28 through opening 18.

Portable electronic device holder 10a also includes a first number (e.g., an even number) of retention members, exemplarily shown as retention members 44 and 46, and a second number (e.g., an odd number) of retention members, exemplarily shown as retention member 48. With respect to the present embodiment, retention members 44 and 46 are coupled to side wall 36 and are disposed to extend into the space 42 of the housing 28 whereas retention member 48 is coupled to side wall 32 and is also disposed to extend into the space 42 of the housing 28. In such an arrangement, retention members 44 and 46 are disposed opposite to retention member 48 within the space 42 of the housing 28. Additionally, retention members 44 and 46 are staggered relative to retention member 48 when viewed from the opening 18. It is contemplated that the retention members 44, 46, 48 may be molded from a thermoplastic elastomer (TPE) or similar material to impart flexibility to the retention members 44, 46, 48. Once molded, the retention members 44, 46, 48 may be integrated with the housing 28 via a two-shot injection molding process containing both the housing 28 and the retention members 44, 46, 48 as separate molding cavities. For example, the housing 28 may be molded during a first-shot injection followed by a second-shot injection for molding the retention members 44, 46, 48 and integrating the same onto the desired locations of the housing 28.

In operation, retention members 44, 46, and 48 cooperate to hold the smart phone 20 in place when it is received in the housing 28. It is contemplated that each of the retention members 44, 46, 48 may be disposed at various depths inside the housing 28. According to the present embodiment, retention members 44 and 46 are spaced horizontally across side wall 36 and are each disposed at a higher depth inside the housing 28. Retention member 48 is centrally located on side wall 32 and is disposed at a lower depth relative to the higher depth at which retention members 44 and 46 are located. Each retention member 44, 46, 48 may be generally shaped as a truncated pyramid having a rounded tip portion 54 that grips onto the smart phone 20 when it's inserted into the housing 28. Given their general locations within the housing 28, retention members 44 and 46 generally grip onto an intermediate portion of the smart phone 20 whereas retention member 48 generally grips onto a lower portion of the smart phone 20. The clearance between the retention members may be slightly smaller than the width of the smart phone 20 such that the tip portion 54 of each retention member 44, 46, 48 deforms against the smart phone 20 to apply sufficient gripping force against the smart phone 20 to prevent it from slipping out of position. When the smart phone 20 is removed from the housing 28, the retention members 44, 46, 48 return to their natural shape.

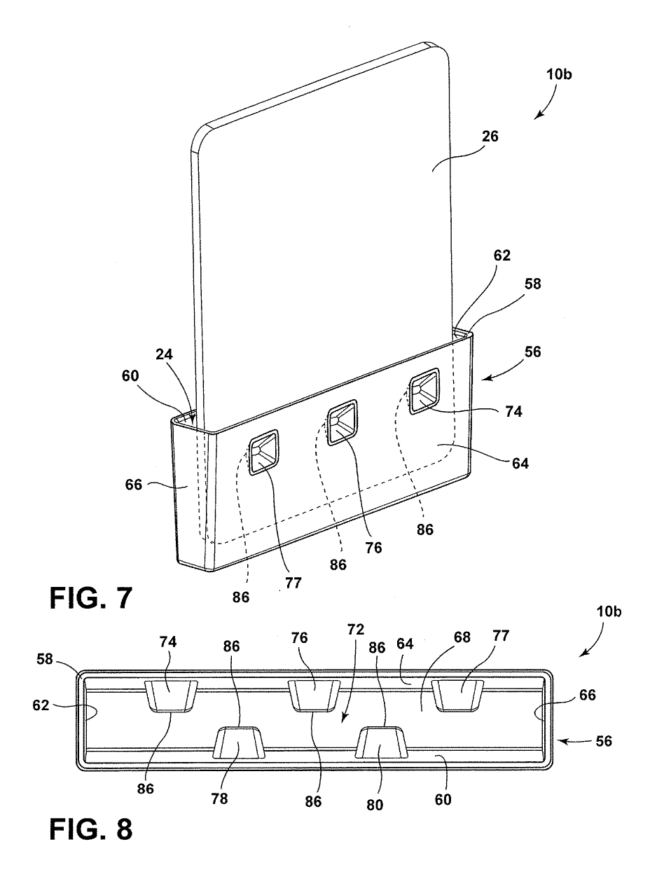

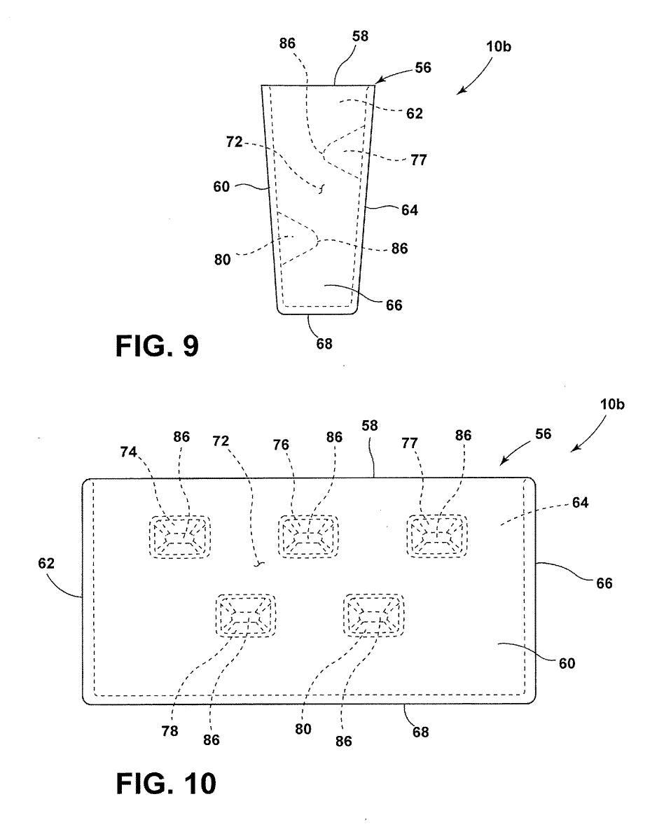

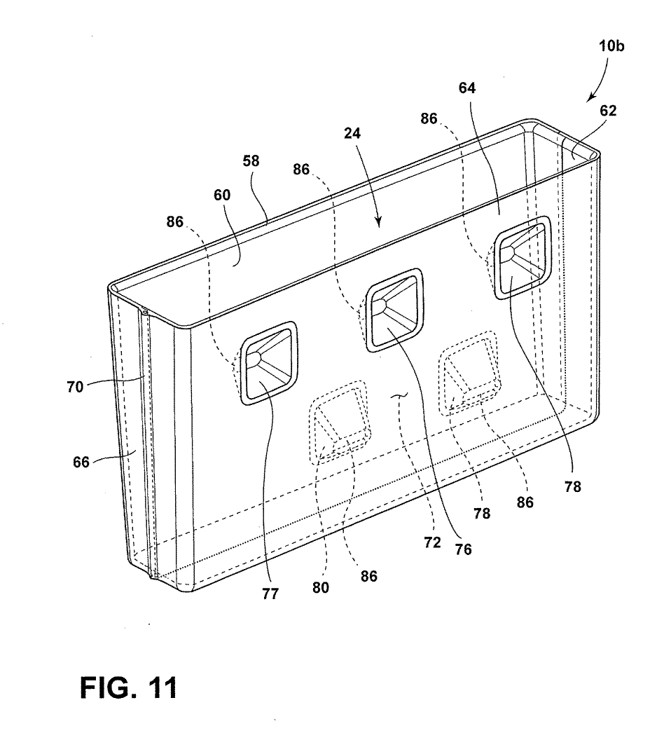

Referring now to FIGS. 7-11, portable electronic device holder 10b is shown according to one embodiment. As shown, portable electronic device holder 10b includes a housing 56 that may be molded from a thermoplastic polymer such as polypropylene or thermoplastic olefin (TPO). The housing 56 includes a top end 58 that defines the opening 24 shown in FIG. 1, side walls 60, 62, 64, and 66, and bottom end 68. In the present embodiment, side walls 62 and 66 are substantially perpendicular with respect to the top and bottom ends 58, 68 whereas side walls 60 and 64 taper toward the bottom end 68. Alternatively, side walls 60 and 64 may be substantially perpendicular with respect to the top and bottom ends 58, 68 of the housing 56. Optionally, the housing 56 may be configured as a clamshell and include a living hinge 70 extending longitudinally across one of the side walls such as side wall 66, as exemplarily shown in FIG. 11. The housing 56 defines a space 72 for accommodating the tablet 26 when it's inserted into the housing 56 through opening 24.

Portable electronic device holder 10b also includes a first number (e.g., an odd) of retention members, exemplarily shown as retention members 74, 76, and 77 and a second number (e.g., an even number) of retention members, exemplarily shown as retention members 78 and 80. With respect to the present embodiment, retention members 74, 76, and 77 are coupled to side wall 64 and are disposed to extend into the space 72 of the housing 56 whereas retention members 78 and 80 are coupled to side wall 60 and are also disposed to extend into the space 72 of the housing 56. In such an arrangement, retention members 74, 76, and 77 are disposed opposite to retention members 78 and 80 within the space 72 of the housing 56. Additionally, retention members 74, 76, and 77 are staggered relative to retention members 78 and 80 when viewed from the opening 24. It is contemplated that the retention members 74, 76, 77, 78, 80 may be molded from a thermoplastic elastomer (TPE) or similar material to impart flexibility to the retention members 74, 76, 77, 78, 80. Once molded, the retention members 74, 76, 77, 78, 80 may be integrated with the housing 56 via a two-shot injection molding process containing both the housing 56 and the retention members 74, 76, 77, 78, 80 as separate molding cavities. For example, the housing 56 may be molded during a first-shot injection followed by a second-shot injection for molding the retention members 74, 76, 77, 78, 80 and integrating the same onto the desired locations of the housing 56.

In operation, retention members 74, 76, 77, 78, and 80 cooperate to hold the tablet 26 in place when it is received in the housing 56. It is contemplated that each of the retention members 74, 76, 77, 78, 80 may be disposed at various depths inside the housing 56. According to the present embodiment, retention members 74, 76, and 77 are spaced horizontally across side wall 64 and are each disposed at a higher depth inside the housing 28. Retention members 78 and 80 are spaced horizontally across side wall 60 and are disposed at a lower depth relative to the higher depth at which retention members 74, 76, and 77 are located. Each retention member 74, 76, 77, 78, 80 may be generally shaped as a truncated pyramid having a rounded tip portion 86 that grips onto the tablet 26 when it's inserted into the housing 56. Given their general locations within the housing 56, retention members 74, 76, and 77 generally grip onto an intermediate portion of the tablet 26 whereas retention members 78 and 80 generally grip onto a lower portion of the tablet 26. The clearance between the retention members 74, 76, 77, 78, 80 may be slightly smaller than the width of the tablet 26 such that the tip portion 86 of each retention member 74, 76, 77, 78, 80 deforms against the smart tablet 26 to apply sufficient gripping force against the tablet 26 to prevent it from slipping out of position. When the tablet 26 is removed from the housing 56, the retention members 74, 76, 77, 78, 80 return to their natural shape.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A portable electronic device holder of a vehicle, comprising:
a housing defining a space therein and having an open end; and
a first and second number of retention members coupled to opposing side walls of the housing and disposed to extend into the space;
wherein the first and second number of retention members cooperate to hold a portable electronic device inserted into the space through the open end.

2. The portable electronic device holder of claim 1, wherein the first and second number of retention members are flexible and include a tip portion that deforms against the portable electronic device to apply sufficient gripping force against the portable electronic device to prevent the electronic device from slipping out of position.

3. The portable electronic device holder of claim 1, wherein one of the first and second number of retention members are located at a lower depth than a depth at which the other of the first and second number of retention members is located within the housing.

4. The portable electronic device holder of claim 1, wherein the first and second number of retention members are staggered relative one another when viewed from the open end.

5. The portable electronic device holder of claim 1, wherein the housing is configured as a clamshell having a living hinge.

6. The portable electronic device holder of claim 1, wherein the opposing side walls taper downward from the open end.

7. The portable electronic device holder of claim 1, configured as a bin assembled to an interior vehicle structure, wherein the portable electronic device is held in one of a flat, upright, and angled position.

8. The portable electronic device holder of claim 1, wherein the housing is molded during a first-shot injection followed by a second-shot injection for molding the first and second number of retention members, the first and second retention members being integrated to their respective side walls.

9. A portable electronic device holder of a vehicle, comprising:
a clamshell housing having a living hinge and defining a space therein and an open end; and
a first and second number of flexible retention members integrated with opposing side walls of the housing and disposed to extend into the space;
wherein the first and second number of flexible retention members cooperate to hold a portable electronic device inserted into the space through the open end.

10. The portable electronic device holder of claim 9, wherein the first and second number of retention members include a tip portion that deforms against the portable electronic device to apply sufficient gripping force against the portable electronic device to prevent the electronic device from slipping out of position.

11. The portable electronic device holder of claim 9, wherein one of the first and second number of retention members are located at a lower depth than a depth at which the other of the first and second number of retention members is located within the housing.

12. The portable electronic device holder of claim 9, wherein the first and second number of retention members are staggered relative one another when viewed from the open end.

13. The portable electronic device holder of claim 9, wherein the opposing side walls taper downward from the open end.

14. The portable electronic device holder of claim 9, configured as a bin assembled to an interior vehicle structure, wherein the portable electronic device is held at an angled position.

15. The portable electronic device holder of claim 9, wherein the housing is molded during a first-shot injection followed by a second-shot injection for molding the first and second number of retention members.

16. A portable electronic device holder of a vehicle, comprising:
a housing defining a space therein and an open end; and
an odd and an even number of retention members integrated with opposing side walls of the housing and disposed to extend into the space;
wherein one of the odd and even number of retention members are located at a lower depth than a depth at which the other of the first and second number of retention members are located within the housing;
wherein the odd and even number of retention members cooperate to hold a portable electronic device inserted at an angle into the space through the open end; and
wherein the odd and even number of retention members are flexible and include a tip portion that deforms against the portable electronic device to apply sufficient gripping force against the portable electronic device to prevent the electronic device from slipping out of position.

17. The portable electronic device holder of claim 16, wherein the odd and even number of retention members are staggered relative one another when viewed from the open end.

18. The portable electronic device holder of claim 16, wherein the housing is configured as a clamshell having a living hinge.

19. The portable electronic device holder of claim 16, configured as a bin assembled to an interior vehicle structure.

20. The portable electronic device holder of claim 16, wherein the housing is molded during a first-shot injection followed by a second-shot injection for molding the first and second number of retention members.
